(19) United States
(12) Patent Application Publication
(10) Pub. No.: US 2026/0121907 A1
(43) Pub. Date: Apr. 30, 2026

(54) BACKUP ACCESS NETWORK CONFIGURATION FOR NETWORK FAILURE RECOVERY

(71) Applicant: AT&T Intellectual Property I, L.P., Atlanta, GA (US)

(72) Inventors: Rashmi Palamadai, Naperville, IL (US); Yupeng Jia, South Pasadena, CA (US)

(21) Appl. No.: 18/926,118

(22) Filed: Oct. 24, 2024

(51) Int. Cl. H04L 41/0663; H04W 24/04

(52) U.S. Cl. CPC H04L 41/0663; H04W 24/04

(57) ABSTRACT

A processing system deployed in a first carrier communication network may detect a network failure of at least a portion of the first carrier communication network, where the network failure prevents a network connectivity for at least a first endpoint device. The processing system may next select, in response to the detecting of the network failure, a second communication network for the at least the first endpoint device from among one or more backup communication networks according to a selection logic, and may configure at least a portion of the second communication network to serve the at least the first endpoint device. The processing system may then establish a network service for at least the first endpoint device via the at least the portion of the second communication network.

The present disclosure relates generally to communication network operators, e.g., a carrier network, and more particularly to methods, computer-readable media and apparatuses for configuring at least a portion of a second communication network that is selected to serve at least a first endpoint device in response to a network failure of a first carrier communication network.

### BACKGROUND

Modern society may increasingly expect continuous network connectivity at any time of the day and day of the week. In many cases, loss of connectivity may be considered an emergency. For example, first responders, governmental entities, medical facilities, home medical devices, and others may rely on consistent connectivity in order to function. In addition, small cells and wireless access points are increasingly prevalent. However, wireless access points and small cells may be deployed at customer premises, and may therefore be more vulnerable to tampering and similar communication security breaches.

### SUMMARY

Methods, computer-readable media, and apparatuses are disclosed for configuring at least a portion of a second communication network that is selected to serve at least a first endpoint device in response to a network failure of a first carrier communication network. For example, a processing system including at least one processor deployed in a first carrier communication network may detect a network failure of at least a portion of the first carrier communication network, where the network failure prevents a network connectivity for at least a first endpoint device; The processing system may next select, in response to the detecting of the network failure, a second communication network for the at least the first endpoint device from among one or more backup communication networks according to a selection logic, and may configure at least a portion of the second communication network to serve the at least the first endpoint device. The processing system may then establish a network service for at least the first endpoint device via the at least the portion of the second communication network.

### BRIEF DESCRIPTION OF THE DRAWINGS

The teachings of the present disclosure can be readily understood by considering the following detailed description in conjunction with the accompanying drawings, in which:

FIG. 1 illustrates an example system related to the present disclosure;

FIG. 2 illustrates a flowchart of an example method for configuring at least a portion of a second communication network that is selected to serve at least a first endpoint device in response to a network failure of a first carrier communication network; and

FIG. 3 illustrates an example high-level block diagram of a computing device specifically programmed to perform the steps, functions, blocks, and/or operations described herein.

To facilitate understanding, identical reference numerals have been used, where possible, to designate identical elements that are common to the figures.

### DETAILED DESCRIPTION

The present disclosure broadly discloses methods, computer-readable media, and apparatuses for configuring at least a portion of a second communication network that is selected to serve at least a first endpoint device in response to a network failure of a first carrier communication network. In particular, as society increasingly expects continuous network connectivity at any time of the day and day of the week, loss of connectivity may often be considered an emergency. For example, first responders, governmental entities, medical facilities, home medical devices, and others may rely on consistent connectivity in order to function. In this regard, examples of the present disclosure address the eventuality of network outages and ensure that appropriate levels of backup systems are in place to maintain connectivity for critical devices, functions/services, and users. In accordance with the present disclosure, a network failure may be caused by large scale outages, e.g., due to loss of electrical power from an electrical power distribution system, network overload, network jamming, natural disasters, and/or related network equipment failure. In one example, a communication network, e.g., a carrier network, such as a cellular service provider/carrier network, may be configured with one or more public or private backup networks. During a network failure event affecting a geographic zone and/or network zone, critical demands within the relevant zone(s) may be assessed. In one example, connectivity via one or more backup networks may be provided to endpoint devices based on priority of demand (e.g., need for network services) and criticality of situation. In one example, the present disclosure may incorporate artificial intelligence (AI)/machine learning (ML)-based evaluation and dynamic allotment of backup network resources, including network slice resources, for critical endpoint devices based on profile and demand (e.g., stated or assessed need). In one example, a primary carrier network may monitor critical devices, and may allocate resources of one or more backup networks based upon location and demand. In one example, the present disclosure may provide tiered service options for endpoint devices of different service categories. In one example, the present disclosure may also include dynamic handoff between backup public/secondary carrier networks and backup private networks in response to one or more defined trigger conditions to ensure continuous service.

In one example, one or more classes of endpoint devices, users, and/or functions/services may have capped/restricted data usage via one or more backup networks, e.g., to help ensure that emergency services/applications are not impacted or are only minimally impacted by a network outage. In other words, non-essential endpoint devices (e.g., identified via device identifiers, users, and/or functions/services operating on such endpoint devices) may be deprioritized within an affected zone. However, it should be noted that in one example, the present disclosure may also offer the ability to change priority of service/tier/category of an endpoint device that is different from an initially assigned category/tier after a network outage.

Examples of the present disclosure include a backup plan for each location that accounts for different categories of endpoint devices to enable continuity of services for critical endpoint devices during natural disasters and/or situations where connectivity via a primary carrier network is impacted (e.g., a network failure). In one example, the present disclosure may include several phases to create an end-to-end system/model of management. For instance, in an analysis and planning phase, a carrier network may identify one or more other carrier networks (e.g., public networks) and/or one or more private networks, such as private cellular networks and/or non-cellular wireless networks (e.g., Wi-Fi network(s), satellite network(s), etc.) as candidates for backup network configuration. In one example, the present disclosure may further identify fixed and/or mobile public and/or private network infrastructure that may serve as hubs or anchor nodes for the creation of a mesh network as an additional backup network option. In one example, for each class/category/tier of endpoint devices, the present disclosure may provide for a primary backup network and one or more secondary backup networks. For instance, different classes of endpoint devices may have different primary and secondary backup networks designated in a given zone.

In one example, in the event of a network failure of a carrier network, the carrier network may implement process steps to re-connect endpoint devices in an affected area/zone. For instance, in one example, a network failure may be detected via ongoing monitoring of network activity. In one example, one or more thresholds may be implemented to detect overload, jamming, power outage(s), and so forth, e.g., by one or more network elements/network functions that are outside of an affected zone. Upon detection, the primary carrier network may immediately alert backup network(s) to ensure network resources are reserved for offloading one or more classes of endpoint devices from the primary carrier network to the one or more backup networks. In addition, when trigger condition(s) are detected, the backup carrier/provider network(s) and/or backup private network(s) may be configured to on-board various endpoint devices.

In one example, one or more backup mesh networks may alternatively or additionally be instantiated. In one example, a mesh network may be optimized for critical demands, e.g., adjusting a cellular backhaul link to provide a strongest signal strength over a medical facility, a police station, a fire department, etc. In one example, access points with backup electrical power sources may serve as hubs of a mesh network. For instance, public facilities, such as police stations, firehouses, hospitals, educational campuses, etc. may include private cellular or non-cellular (e.g., Wi-Fi) network connectivity for areas in and around such venues. In one example, network resources may be allocated to ensure a certain level of service via the backup network(s) for one or more classes/tiers. For instance, the network resources may include bandwidth of an air interface and/or one or more backhaul links, processor and/or memory resources, and so forth. In one example, this phase may comprise network slice provisioning. For instance, a backup network comprising another cellular carrier network may provide dedicated slice resources to endpoint devices being offloaded from the primary carrier network that has suffered a network outage. For instance, network slicing represents a virtual network architecture that allows multiple virtual networks to be created on the same radio access network and/or cellular core, and treated differently from one another. In one example, endpoint devices may have been assigned categories/tiers, with different network access/service priorities and levels of service (e.g., quality of service (QoS)). For instance, first responder devices may have a category that is provided with a highest level of service. In one example, network-communication-capable medical equipment may also be assigned to this category or to a next category. Other endpoint devices may be assigned one or more additional categories with lesser priority and/or lesser level of services. However, in one example, individuals may have their own choice of primary backup network and one or more secondary backup networks.

As noted above, when a network failure is detected, backup carrier and/or private network(s) resources may be activated. In one example, one or more mesh networks may be activated as a secondary level of backup in the event that one or more primary backup networks also suffer outages. However, in another example, a mesh network may also be considered as a primary backup network for one or more classes of endpoint devices. In one example, endpoint devices that are not of a designated class or classes (e.g., high-priority first responders or governmental entity devices, medical equipment, etc. and/or devices of users/entities that have reserved higher levels of services) may be assigned to a backup network and may be provided with lower data usage privileges.

In a next phase, network access services provided to offloaded endpoint devices may be monitored on an ongoing basis for service upgrade and/or downgrade depending upon a change of priority (e.g., a first responder changing from off-duty to on-duty, or vice versa, a reporter entering an outage zone or leaving an outage zone, etc.), a civilian endpoint device being directly called from a first responder endpoint device, an emergency services dispatch system, or the like, and so forth. In one example, the primary carrier network may assess collective demands of various endpoint devices that are offloaded, and may instruct/request one or more backup networks to reconfigure, e.g., to provide additional resources and/or otherwise provide a higher level of service to the offloaded endpoint devices of one or more classes. For instance, a backup carrier network may activate a network slice in response to a notification of a network failure of the primary carrier network. However, at a later time, the network failure may become more widespread and additional endpoint devices may become affected. Thus, it may be appropriate for the designated slice in the backup carrier network to be reconfigured for additional bandwidth, additional network functions (e.g., more user plane functions (UPFs)/packet data network gateways (PDN GWs), etc.), and so forth. Alternatively, or in addition, backup networks may be monitored to ensure that endpoint devices have an appropriate coverage for their respective demands. For instance, it may be possible that a backup network cannot increase resource allocation to service all of the endpoint devices offloaded from the primary carrier network. As such, the backup network(s) may be requested/instructed to de-prioritize communications for lower priority tier(s) of endpoint devices.

Likewise, it may be determined that conditions may offer a higher level of service from a secondary backup network as compared to a primary backup network. For example, the secondary backup network may not suffer a complete outage, but may still be affected by the same natural disaster or other events that caused a network outage of the primary carrier network. Thus, for instance, a satellite access network may provide the highest level of service for a select set of critical devices that may be switched to the satellite network as a secondary backup network. However, it should be noted that if it were attempted to service all of the affected endpoint devices with unrestricted high bandwidth connections via the satellite network, the level of service could be unacceptably low for all endpoint devices. In other words, the primary carrier network may continue to evaluate the best alternative(s) from among other carrier networks, satellite/non-terrestrial networks, mesh networks, and so forth. Lastly, when restoration of network services from the primary carrier network is detected for the affected zone, the one or more backup networks may be notified to de-allocate resources from the offloaded endpoint devices, e.g., to dismantle and/or deactivate a network slice, etc. In one example, affected endpoint devices may be notified via broadcast from restored resources of the primary carrier network, e.g., from re-activated cellular base stations or the like.

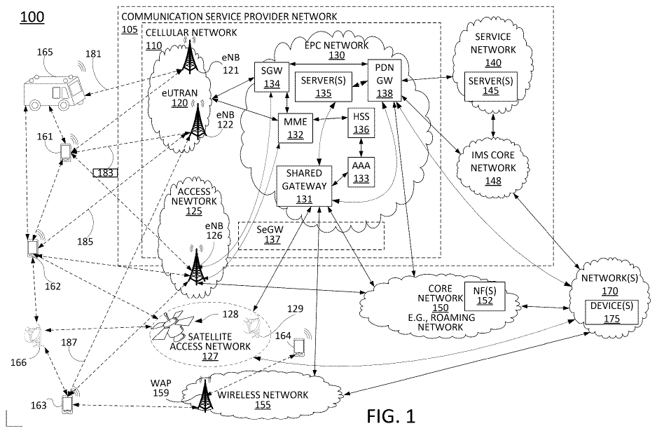

In one example, the present disclosure may integrate with emergency services to ensure backup network resources are available for broadcast messaging, localized communications, and/or personalized communications in various scenarios. In one example, the present disclosure may also incorporate non-terrestrial-networks (NTNs), e.g., comprising satellite and/or aerial-based access points, as part of the backup solution/mesh network capability enhancement. In one example, the present disclosure may incorporate AI/ML techniques to optimize for the best backup plans, e.g., optimizing assignments of endpoint device classes/tiers to backup network options associated with a given network outage zone, and the different sets of resources, levels of service (e.g., QoS) or the like, to reserve for each class of endpoint devices from the backup network(s). Thus, examples of the present disclosure help ensure connectivity for critical devices, such as first responder devices, network-connected medical equipment, or the like, in response to network outages resulting from natural disasters, armed conflicts, deliberate cyber-attacks on a carrier network and/or an electrical power distribution system serving the carrier network, and so forth. These and other aspects of the present disclosure are discussed in greater detail below in connection with the examples of FIGS. 1-3.

To better understand the present disclosure, FIG. 1 illustrates an example network, or system 100 in which examples of the present disclosure may operate. In one example, the system 100 includes a communication service provider network 105 (e.g., a carrier network, or carrier communication network). The communication service provider network 105 may comprise a cellular network 110 (e.g., a Long Term Evolution (LTE) network, or the like), a service network 140, and a core network, e.g., an IP Multimedia Subsystem (IMS) core network 148. The system 100 may further include other networks 170 connected to the communication service provider network 105. As shown in FIG. 1, the system 100 may connect endpoint devices 161-164 with each other, with devices in communication service provider network 105, with devices 175 in networks 170, and/or with other components of communication service provider network 105. The endpoint devices 161-164 may each comprise a cellular telephone, a smartphone, a tablet computing device, a laptop computer, a pair of computing glasses, a wireless enabled wristwatch, or any other wireless and/or cellular-capable mobile telephony and computing device (broadly, a “mobile endpoint device”). In one example, the endpoint devices 161-164 may each comprise a device of a subscriber or customer of the communication service provider network 105. In accordance with the present disclosure, one or more of endpoint devices 161-164 may be associated with first responders or other priority users (e.g., users associated with governmental entities, users with documented medical needs, etc.). Similarly, in one example, one or more of endpoint devices 161-164 may comprise network-connected and/or network-communication-capable medical equipment (e.g., biomedical devices, biometric devices, etc.). In one example, one or more of endpoint devices 161-164 may alternatively or additional comprise network-connected and/or network-communication-capable sensor devices (e.g., Internet of Things (IoT)/smart city infrastructure). As such, these sensor devices may also be assigned to a designated class with a higher priority over other non-critical classes of endpoint devices, e.g., gaming consoles, etc.

In one example, the cellular network 110 may comprise an access network and a core network. For example, as illustrated in FIG. 1, cellular network 110 may comprise an evolved Universal Terrestrial Radio Access Network (eUTRAN) 120 and an evolved packet core (EPC) network 130. The eUTRANs are the air interfaces of the 3^{rd} Generation Partnership Project (3GPP) LTE specifications for mobile networks. In one example, EPC network 130 provides various functions that support wireless services in the LTE environment. In one example, EPC network 130 is an Internet Protocol (IP) packet core network that supports both real-time and non-real-time service delivery across a LTE network, e.g., as specified by the 3GPP standards. In one example, all eNodeBs, e.g., including eNodeB (eNB) 121 and eNodeB (eNB) 122 in the eUTRAN 120, are in communication with the EPC network 130. In one example, endpoint devices 161 and 162 (e.g., user equipment (UEs)), may access wireless services via cellular base stations, e.g., eNodeBs 121 and 122 located in eUTRAN 120. It should be noted that any number of eNodeBs can be deployed in an eUTRAN.

In EPC network 130, network devices Mobility Management Entity (MME) 132 and Serving Gateway (SGW) 134 support various functions as part of the cellular network 110. For example, MME 132 is the control node for the LTE access networks, e.g., including eUTRAN 120. In one embodiment, MME 132 is responsible for user equipment tracking and paging (e.g., such as retransmissions), bearer activation and deactivation process, selection of the SGW, e.g., SGW 134, and user authentication. In one embodiment, SGW 134 routes and forwards user data packets, while also acting as the mobility anchor for the user plane during inter-eNodeB handovers and as the anchor for mobility between LTE and other wireless technologies, such as 2G and 3G wireless networks.

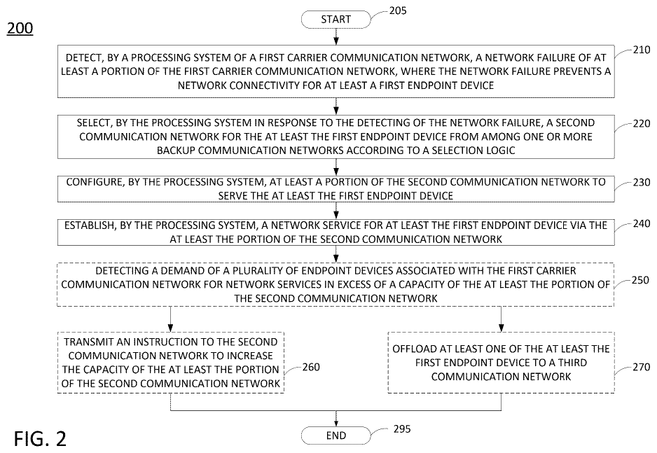

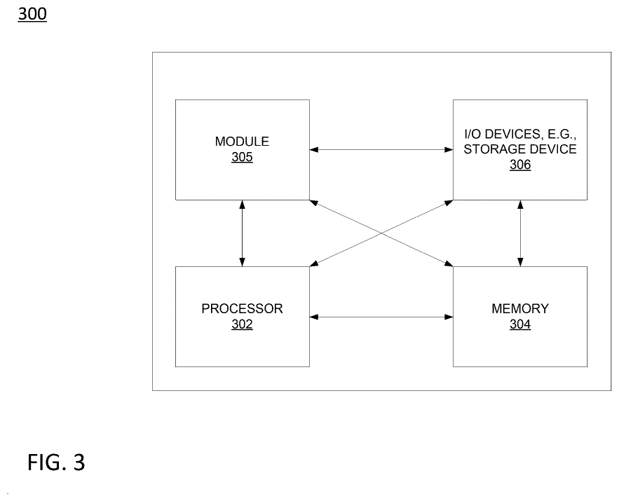

In addition, EPC (common backbone) network 130 may comprise a Home Subscriber Server (HSS) 136 that contains subscription-related information (e.g., subscriber profiles), registration data, and network policy rules, and that performs authentication and authorization of a wireless service user. Thus, HSS 136 may store information regarding various subscriber/customer devices, such as endpoint devices 161-164. HSS 136 may also maintain and provide information about subscribers'locations. In one example, Authentication, Authorization, and/or Accounting (AAA) server 133 obtains subscriber profile information from HSS 136 to authenticate and authorize endpoint devices to connect to EPC network 130 via Institute for Electrical and Electronics Engineers (IEEE) 802.11 (Wi-Fi)/non-3GPP access networks. The EPC network 130 may also comprise a packet data network (PDN) gateway 138 which serves as a gateway that provides access between the EPC network 130 and various data networks, e.g., service network 140, IMS core network 148, networks 170, and the like. The packet data network gateway 138 is also referred to as a PDN gateway, a PDN GW or a PGW. In one example, system 100 may also include one or more servers 135. In one example, server(s) 135 may each comprise a device, such as computing system 300 depicted in FIG. 3, which may individually or collective comprise a processing system specifically configured to provide one or more functions for configuring at least a portion of a second communication network that is selected to serve at least a first endpoint device in response to a network failure of a first carrier communication network, in accordance with the present disclosure. For instance, an example method 200 for configuring at least a portion of a second communication network that is selected to serve at least a first endpoint device in response to a network failure of a first carrier communication network is illustrated in FIG. 2 and described in greater detail below.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, service network 140 may comprise one or more devices, such as server(s) 145 for providing services to subscribers, customers, and/or users. For example, communication service provider network 105 may provide a cloud storage service, web server hosting, and other services. As such, service network 140 may represent aspects of communication service provider network 105 where infrastructure for supporting such services may be deployed. It should be understood that service network 140 may include any number of components to support one or more services that may be provided to one or more subscribers, customers, or users by the communication service provider network 105.

In one example, networks 170 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 170 may include different types of networks. In another example, the other networks 170 may be the same type of network. In one example, the other networks 170 may represent the Internet in general. Devices 175 may include servers, such as web servers, storage devices, enterprise servers, email servers, and so forth. Devices 175 may also include personal computers, desktop computers, laptop computers, personal digital assistants (PDAs), tablet computing devices, or any other devices for wireless and/or wired communications. In one example, endpoint devices 161-164 may communicate with devices 175 in networks 170 via PDN GW 138 and/or via PDN GW 138 and IMS core network 148, e.g., for voice over LTE (VoLTE)-based calls or Wi-Fi calling.

In one example, system 100 may also include an access network 125 with an eNodeB (eNB) 126. The eNodeB 126 (also referred to herein as eNB 126) may comprise, for example, a home eNodeB (HeNB), a “small cell,” such as a femtocell, a microcell, etc., and/or a “low power” eNodeB. For instance, eNB 126 may have a range of 2 kilometers or less, while eNodeBs 121 and 122 may have a range of up to 35 kilometers or more. In one example, access network 125 and eNB 126 may connect to EPC network 130 via a subscriber/customer broadband connection. For instance, access network 125 may comprise a home network of a customer/subscriber and eNodeB 126 may connect via a home gateway (not shown) or similar equipment deployed at the customer premises to SGW 134 and MME 132 in EPC network 130, e.g., via S1 interfaces. While access network 125 may comprise a home network, eNodeB 126 may continue to be managed by a communication service provider network 105 or may be managed by a customer/subscriber associated with access network 125. In addition, in accordance with the present disclosure, in one example, communication service provider network 105 may be enabled to allow open use of access network 125 in response to network failure events related to the “public” portion of communication service provider network 105 (e.g., eUTRAN 120, or the like).

In one example, access network 125 and eNodeB 126 may further connect to SGW 134 and MME 132 via a security gateway (SeGW) 137. SeGW 137 may provide an anchor point for secure communications between eNodeB 126 and EPC network 130. In particular, since access network 125 may comprise a customer premises, it may be more vulnerable to attack and compromise, and may provide a vector for entry into communication service provider network 105 and EPC network 130. Thus, in one example, SeGW 137 may establish an IP security (IPsec) tunnel between itself and the eNodeB 126. The SeGW 137 may comprise a firewall or perform similar functions to analyze and filter traffic from eNodeB 126 before passing the traffic to SGW 134 or MME 132, or alternatively dropping the traffic or passing the traffic to a quarantine device or other network based devices, e.g., for further analysis, malicious traffic signature generation, and so forth.

In still another example, access network 125 may comprise a portion of a peer network, e.g., of a different communication service provider network. Similarly, the access network 125 may comprise a private cellular network. For instance, in one example, access network 125 may be made available by a host mobile network operator (MNO) that provides for shared use of access network 125 by other MNOs, such as communication service provider network 105. For example, the host MNO may control, configure, and/or adjust RAN resources based on the number of bearers, the bandwidth, the spectrum, and other factors being utilized by UEs of each MNO. For instance, the host MNO may reconfigure access network 125 in response to notification of network failure events of communication service provider network 105. The host MNO may further reconfigure access network 125 based on data volumes or demand, the spectrum bands and/or quantity of spectrum used by UEs of each guest MNO (e.g., communication service provider network 105) and for each class/tier (e.g., indicated by quality control indicator (QCI) type and/or another identifier that is specific to network outage backup scenarios, and so forth). For example, the host MNO may adjust transmit power, tilt, or other aspects, which may change a footprint of a cell, may change handover parameters, may change to a different handover algorithm, may steer more UEs offloaded from communication service provider network 105 to a particular spectrum band or away from a particular spectrum band, may activate or deactivate one or more spectrum bands, may allow UEs to use more or less secondary bearers, and so forth.

In addition, with 5G and Citizens Broadband Radio Service (CBRS) spectrum, more nontraditional mobile network operators (MNOs) are seeking to test and implement private cellular networks for their campuses, facilities, cities, etc. As such, the description of access network 125 herein is equally applicable to another carrier network operated access network 125 or a private cellular network. In both cases, a host MNO may share radio access network (RAN) resources (and in some cases, all or some core network assets). For instance, in some cases, the private cellular MNO may deploy and operate its own cellular core network (or “packet core”). In this regard, FIG. 1 further illustrates a core network 150 (e.g., a cellular core network, such as another EPC, or the like) with one or more network functions (NFs) 152). These NFs 152 may represent the same or similar components as illustrated in EPC network 130 and discussed above. Accordingly, in some examples a backup network configuration may utilize only access network portions of a different carrier network and/or private network. For instance, UEs associated with communication service provider network 105 affected by a network outage may be served via access network 125, while still being served via EPC core network 130. However, in other examples, affected UEs may be served by access network 125 and core network 150. For example, these may comprise full roaming scenarios for each UE. Nevertheless, in accordance with the present disclosure communication service provider network 105 may still be enabled to reconfigure aspects of access network 125 and/or core network 150 to accommodate the additional traffic of affected UEs of communication service provider network 105 that are offloaded to the other MNOs'networks, in part (e.g., access network 125 only) or in full (e.g., access network 125 plus core network 150).

In this regard, in one example, EPC network 130 may also include a shared gateway 131. In one example, shared gateway 131 may comprise an evolved packet data gateway (ePDG), a trusted wireless local area network (WLAN) authentication, authorization, and accounting (AAA) proxy (TWAP), and a trusted WLAN access gateway (TWAG). In other words, shared gateway 131 may comprise a device that is configured to provide functions of all of an ePDG, a TWAP and a TWAG. In one example, ePDG functionality of the shared gateway 131 may process traffic from endpoint devices accessing the EPC network 130 via untrusted wireless networks (e.g., IEEE 802.11/Wi-Fi networks), while TWAP/TWAG functionality of shared gateway 131 may process traffic from endpoint devices accessing the EPC network via trusted wireless networks (e.g., IEEE 802.11/Wi-Fi networks).

To further illustrate, in one example, wireless access point (WAP) 159, in wireless network 155 may comprise an untrusted WAP. Thus, wireless network 155 may comprise an untrusted wireless network. In one example, WAP 159, e.g., a wireless router that may communicate with endpoint device 164 via an IEEE 802.11/Wi-Fi based link, connects to shared gateway 131 via an S2b interface. For example, endpoint device 164 may be connected to shared gateway 131 via a secure tunnel, e.g., an IPsec tunnel, wherein traffic carried via the secure tunnel is passed via the WAP 159, but is indecipherable to the WAP 159. For example, the payload data may be encrypted using an encryption key, or keys, which may be held by endpoint device 164 and shared gateway 131, but which WAP 159 does not possess. In one example, the secure tunnel between the endpoint device 164 and shared gateway 131 may comprise a SWu interface. In another example, WAP 159 may represent a trusted WAP. Thus, wireless network 155 may comprise a trusted wireless access network. In such an example, WAP 159 may connect to shared gateway 131 via an S2a interface. For instance, the link between WAP 159 and shared gateway 131 may also comprise an IPsec tunnel. However, it should be noted that the IPsec tunnel terminates at WAP 159 and not at the endpoint device 164, in contrast to the example where WAP 159 is untrusted, where a secure tunnel is established between the shared gateway 131 and the endpoint device 164.

Wireless networks and WAPs may be designated as “trusted” or “untrusted” based upon several factors, such as whether the wireless network is a customer or subscriber network, a governmental, educational, medical, or other institutional networks, a peer network, e.g., of a different communication service provider, based upon a model or type of WAP, and so forth. In one example, wireless network 155 and WAP 159 may be untrusted insofar as the wireless network 155 may comprise a customer premises network of a local governmental entity, which may be more susceptible to tampering and other types of information security breaches as compared to communication infrastructure that is under the control of an operator of the communication service provider network 105. In addition, in one example, a trust designation of a WAP or wireless access network may be changed, e.g., from “trusted” to “untrusted,” based upon various events, such as an invalidity of a security certificate of a WAP, a detection of a port opening at the WAP, and so forth.

In one example, wireless network 155 may further be connected to shared gateway 131 via SeGW 137. For instance, in one example, SeGW 137 may serve as an anchor point for secure communications between EPC network 130 and external devices. Thus, in another example, a secure tunnel (e.g., an IPsec tunnel) may be established between WAP 159 and SeGW 137, e.g., instead of a secure tunnel being established between trusted WAP 159 and shared gateway 131. Similarly, a secure tunnel may be established between endpoint device 164 and SeGW 137, e.g., instead of a secure tunnel between endpoint device 164 and shared gateway 131. It should be noted that SeGW 137 may comprise a component of EPC network 130, or may comprise a component of cellular network 110 that is considered to be external to the EPC network 130.

As illustrated in FIG. 1, the system 100 may further include a satellite access network 127 that includes a satellite 128 and a ground station 129. For instance, ground station 129 may receive data (e.g., from devices 175 in networks 170, etc.) for uplink transmission to satellite 128. Accordingly, satellite 128 may receive the uplink data and may then re-transmit the data to any endpoint devices within a coverage area of satellite 128 (and which are satellite communication capable), such as satellite transceiver 166, e.g., a satellite link terrestrial antenna (including satellite dishes and antennas for downlink communications, or for both downlink and uplink communications). Likewise satellite 128 may receive uplink data from satellite transceiver 166 (and/or other satellite communication capable endpoint devices) and may re-transmit such data to ground station 129 for forwarding to an intended destination device, such as one of devices 175, etc. In the present example, satellite access network 127 may be controlled and/or operated by an entity that is different from the communication service provider network 105. As such, in different examples, satellite access network 127 may be designated as trusted or untrusted, such that data ingress and egress to the cellular network 110 and/or communication service provider network 105 is via shared gateway 131, or via SeGW 137 and shared gateway 131.

In accordance with the present disclosure, communication service provider network 105 may coordinate with other networks (and/or endpoint devices that may be configured to comprise a mesh network) to create a backup network transition process in the event of network failures with respect to various geographic areas/locations and/or network zones of communication service provider network 105. For instance, in the example of FIG. 1, in the event of a network failure affecting eNB 122, there may be several backup network options, including: access network 125, wireless network 155, and satellite access network 127. In addition, in one example, communication service provider network 105 may enable the establishment of temporary cells, e.g., a mobile cell. For example, a first responder or another vehicle 165 may be equipped with mobile base station equipment (e.g., a cell on wheels (CoW)), which can be activated in response to an occurrence of the network outage (as well as in other scenarios, such as to provide enhanced cellular network coverage in areas of mass gatherings, such as large sporting events, concerts, etc.). In one example, vehicle 165 may establish a connection to cellular network 110/communication service provider network 105 via a mobile backhaul link 181. For instance, vehicle 165 may be deployed to an area affected by the network outage (e.g., a cell/coverage area of eNB 122). In addition, in the present example, the vehicle 165 may establish a high bandwidth mobile backhaul link to eNB 121. Accordingly, endpoint devices that were within communication range of eNB 122 but not within communication range of eNB 121, such as endpoint device 161, may instead obtain network connectivity via vehicle 165, which may be at an intermediate position within the communication range of endpoint device 161 and eNB 121.

In an illustrative scenario, communication service provider network 105 may provide a backup connectivity system in response to network outages. For instance, communication service provider network 105 may provide such a service for endpoint devices via server(s) 135 or the like. To further illustrate, server(s) 135 may maintain an emergency network service plan for a network zone, area, or the like, in which one or more classes of endpoint devices (or individual endpoint devices and/or accounts) are assigned/associated with one or more backup networks with respect to network outages, e.g., a primary backup network and one or more secondary backup networks, which may further include an order of preference. In one example, each endpoint device, account, or class of endpoint device may be further assigned/associated with a level of service (e.g., a QoS) to be provided via the primary and/or one or more secondary backup networks. It should be noted that a primary backup network is not necessarily the one that provides the highest level of service to an endpoint device, but may be one that may provide the most appropriate level of service according to the interests of other entities, classes of endpoint devices, and/or the capabilities and availability of other networks. For instance, an endpoint device of an off-duty first responder may be assigned to a class that is associated with a first backup network and a first level of service that provides minimal access for off-duty first responders. However, this can be switched if the off-duty first responder volunteers and becomes an active participant in a disaster recovery and thus subsequently obtains a higher priority for enhanced network services. This can be indicated by a designation from a supervisory or other authorized/designated coordinator first responder devices or the like. Alternatively, or in addition, a user or entity may pay for a premium backup service, but a primary backup network capable of providing this level of service may also be affected by a power outage or the like. Thus, an endpoint device of such a user/entity may still be directed to a secondary backup network that may offer a lesser level of service (e.g., satellite access network 127 instead of access network 125, or the like).

In one example, server(s) 135 may incorporate AI/ML techniques to optimize for the best backup plans, e.g., optimizing assignments of endpoint devices, or endpoint device classes/tiers, to backup network options associated with a given network outage zone, and the different sets of resources, levels of service (e.g., QoS) or the like to reserve for each class of endpoint devices from the backup network(s). For instance, a machine learning model (MLM), e.g., a trained machine learning algorithm (MLA), may be trained to output a selection of a backup network for a given endpoint device or class of endpoint devices based upon inputs comprising: available backup networks, a type network outage, an anticipated duration of network outage, a severity of network outage, an affected location, an affected area, an affected network element(s), an affected network zone, a date, a time, a season, a temporal factor, and/or other factors. In one example, the output may also include a recommended set of resources and/or levels of services to be provided to the endpoint device or a class of endpoint devices.

It should be noted that as referred to herein, a machine learning model (MLM) (or machine learning-based model) may comprise a machine learning algorithm (MLA) that has been “trained” or configured in accordance with input data (e.g., training data) to perform a particular service, e.g., to select a backup network, a level of service within a backup network, and or set of network resources to reserve for an endpoint device or class of endpoint devices in response to a network outage. Examples of the present disclosure may incorporate various types of MLAs/models that utilize training data, such as support vector machines (SVMs), e.g., linear or non-linear binary classifiers, multi-class classifiers, deep learning algorithms/models, such as deep learning neural networks or deep neural networks (DNNs), generative adversarial networks (GANs), decision tree algorithms/models, k-nearest neighbor (KNN) clustering algorithms/models, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. In one example, MLMs of the present disclosure may be in accordance with a MLA/MLM template from an open source library, such as OpenCV, which may be further enhanced with domain specific training data. In one example, different MLMs may be trained and deployed for different network failure types, for different locations/areas, network elements, and or network zones, for different classes of endpoint devices, and so forth.

To further illustrate, in the event of an outage affecting eNB 122, endpoint devices 161, 162, and 163 may lose connectivity (e.g., via wireless links 183, 185, and 187). In one example, communication service provider network 105 may have pre-existing agreements in place with access network 125, satellite access network 127 and wireless network 155 to provide backup services to endpoint devices of communication service provider network 105 in the event of network outages. In one example, communication service provider network 105 may offer its own infrastructure for backup services for another carrier network. In one example, a primary backup network for a first class of endpoint devices, e.g., first responder devices, may be designated as the access network 125. For instance, access network 125 may be capable of absorbing only 10 percent of the endpoint devices affected by the network outage while maintaining the same QoS that the devices receive within communication service provider network 105. Continuing with the present example, endpoint devices 161 and 163 may be first responder devices and may be granted access by eNB 126 when access network 125 is notified by communication service provider network 105 of the network failure. For example, server(s) 135 may determine that a network outage associated with eNB 122 has occurred, and may send a request/instruction(s) to access network 125 to permit endpoint devices 161 and 163 to attach to eNB 126. On the other hand, endpoint device 162 may comprise a non-first responder device, e.g., assigned to a different class/category. Accordingly, in one example, endpoint device 162 may be assigned to the wireless network 155 also serving as a backup network.

As noted above, in some cases, a primary backup network is not necessarily a network that may provide the highest level of service to a particular endpoint device, but may simply be one that serves an overall goal of the communication service provider network 105 to support critical services in response to network outages. Thus, for example, a primary backup network for non-first responder mobile smartphones may be satellite access network 127, where the endpoint devices offloaded from the communication service provider network 105 may be permitted to send and receive short message service (SMS) text messages and/or voice communications to and from emergency service entities, but where other types of communication may be blocked. Alternatively, or in addition, such endpoint devices may be permitted to receive any type of communication originating from an emergency service entity over the satellite access network 127, but may have uplink communications restricted to SMS only, for instance. In one example, endpoint devices that are not equipped for satellite communication may still utilize satellite access network 127 to support a minimum level of data traffic via satellite transceiver 166. For instance, satellite transceiver 166 may be further equipped for terrestrial wireless communication, such as IEEE 802.11/Wi-Fi communication, or cellular sidelink/peer-to-peer communication, and may facilitate usage of satellite access network 127 by an endpoint device that does not have direct satellite communication capability.

In one example, an endpoint device may have a level of service increased and/or a class/tier of the endpoint device may be changed (resulting in a change in a level of service and/or serving backup network). For example, in response to a trigger condition, such as an emergency service entity attempting to initiate a video call with endpoint device 162, a level of service provided by satellite access network 127 to endpoint device 162 may be increased. For instance, server(s) 135 may transmit instructions to satellite access network 127 to increase permitted downlink and/or uplink bandwidth for endpoint device 162 that is sufficient to accommodate a video call. In another example, server(s) may transmit an instruction to endpoint device 162 to switch to access network 125, and may simultaneously transmit an instruction to access network 125 to grant access to endpoint device 162. In a similar scenario, a first responder (e.g., using endpoint device 163) may be off duty and may be assigned to wireless network 155 as a backup network in response to an outage affecting eNB 122 of eUTRAN 120. However, if the first responder is beginning a work shift, or is volunteering to assist those on duty, then the first responder may have a level of service upgraded within a current backup network and/or may have the backup network changed to a secondary backup network (such as access network 125, which may provide a higher level of service).

In one example, communication service provider network 105 may provide for backup electrical power at one or more designated base stations/cell sites to maintain a minimum level of connectivity in an area, e.g., in conjunction with an ad-hoc mesh network. For instance, a widespread power outage may affect eNB 122. However, eNB 121 may be equipped with an on-site power generator. Accordingly, eNB 121 may communicate with endpoint devices within communication range of eNB 121. Endpoint devices that may be out of range for direct communication with eNB 121 (such as endpoint device 162) may still be within peer-to-peer communication range of another endpoint device that is within range of eNB 121 (such as endpoint device 161). In one example, a backup mesh network may be established in response to a network failure regardless of the availability of other backup networks. For instance, a mesh network may be made available as a default fallback in the event that primary or other secondary backup networks become unavailable. Alternatively, or in addition, it may be the case that in some areas, a mesh network may provide the best connectivity and/or level of service for various endpoint devices, or one or more classes of endpoint devices. In one example, a mesh network may be specifically enhanced via one or more mobile and/or temporary base stations. For instance, vehicle 165 may position itself within the mesh network and establish connectivity to endpoint devices 161 and 162, along with a wireless backhaul via link 181 to eNB 121.

It should be noted that communication service provider network 105 may detect (e.g., via server(s) 135) a network failure in any number of ways, such as by one or more network elements reporting a link failure, a threshold period of time passing without receiving a heartbeat message from one or more network elements, a notification from a network element that the network element or another neighboring network element is or will be taken offline, a notification from a network element that a link will be disconnected or is currently disconnected, a failure to respond to an inquiry or command, and so forth. In one example, when server(s) 135 detect a network event, the server(s) 135 may identify a region that is/are affected as well as the affected endpoint devices. Servers 135 may then attempt to send instructions to peering devices at or near to the region to establish a mesh network to avoid or circumvent the network disruption. The location(s)/region(s) may be identified by geographic coordinates and/or may be identified in reference to a network topology map, a network provisioning database, or the like. For instance, interconnected links and devices may be indicated by such a map or provisioning database. To illustrate, server(s) 135 may send one or more broadcast messages to any peered device within communication range of eNB 121. The broadcast message(s) may be cellular broadcast message(s) or non-cellular wireless broadcast message(s). In one example, the broadcast message(s) may comprise a Wi-Fi Direct peer discovery message. Upon any endpoint device receiving the broadcast message, the endpoint device may then activate a functionality of being a node in a mesh network. In the example of FIG. 1, at least endpoint device 161 is within communication range of eNB 121 and/or vehicle 165. In one example, endpoint device 161 may retransmit the message from server(s) 125, and/or transmit one or more new messages to any peering devices within communication range of endpoint device 161, e.g., where the message(s) further instruct(s) any other endpoint devices to reconfigure to be part of the peer-to-peer network. In the example of FIG. 1, endpoint device 162 is reachable in this way. The message(s) retransmitted by endpoint device 161 may comprise one or more non-cellular wireless broadcast messages, wireless ad-hoc networking protocol discovery messages, such as a Wi-Fi peer-to-peer/Wi-Fi Direct peer discovery messages, or the like. In one example, each of the endpoint devices receiving such a message may contact one or more other endpoint devices with a peer-to-peer invite request (e.g., Wi-Fi Direct peer invite) to establish the actual peer-to-peer links between peering devices. Endpoint device 162 may also retransmit the message(s) from server(s) 135 and/or transmit one or more new messages to any other peering devices, e.g., eNB 126, in range of endpoint device 162.

In addition to establishing a backup mesh network, server(s) 135 may further configure one or more backup networks for providing network services to affected endpoint devices. The backup networks may be identified in accordance with pre-existing permissions from the backup networks to allocate network resources to communication service provider network 105 in response to network outages. In one example, server(s) 135 may instruct the backup network(s) as to which endpoint devices, or classes of endpoint devices should be permitted to obtain network service, and the respective level(s) of service to provide the endpoint devices via each of the respective backup networks. Likewise, server(s) 135 may transmit instructions to various endpoint devices as to the permitted backup network(s) that the respective endpoint devices may use, the level(s) of service to expect, and so forth. In one example, the allocation of endpoint devices to backup networks may be in accordance with an assignment/selection logic. In one example, the selection logic may comprise one or more rules, tables, decision trees, or the like. Factors that may affect the assignments of endpoint devices to backup networks may include, the number of affected endpoint devices, the types/classes of endpoint devices and their anticipated levels of demand for network services (e.g., bandwidth demand, processor utilization demand, memory utilization demand, etc.), the location(s)/area(s) affected, the forecast duration of a network outage, a severity level of the outage, and so forth. In one example, as noted above, the decision logic may be AI/ML-based. For instance, an AI/ML model may take inputs comprising: available backup networks, type or anticipated duration of network outage, severity, the affected location, area, network element(s), and/or network zone, the date, time, season, or other temporal factors, and other factors, and may output a recommended backup network for a given endpoint device or a class of endpoint devices. In one example, the output may also include a recommended set of resources and/or a level of service to be provided to the endpoint device or the class of endpoint devices.

In one example, server(s) 135 may remain in communication with the backup networks and/or with offloaded endpoint devices to continuously monitor the levels of service being provided, the actual data traffic volumes, and so forth. In this regard, server(s) 135 may permit upgrades to the level of service and/or the backup network to which an endpoint device is assigned based upon changing circumstances, such as failures affecting backup networks, increased load as a result of communication service provider network 105 offloading to one or more access networks, a change in status of an endpoint device/user (e.g., first responder going on duty or off duty, a reporter entering an area for news gathering, a user suffering a medical issue, etc.). Similarly, server(s) 135 may continuously monitor for a resolution of a network outage and may return endpoint devices to communication service provider network 105, e.g., gradually by subsets of endpoint devices and/or classes of endpoint devices. In one example, server(s) 135 may also transmit instructions to backup networks and/or endpoint devices in a mesh network configuration to release network resources back for general use (e.g., resources are no longer actively reserved for backing up communication service provider network 105). These and other aspects of the present disclosure are further described in connection with the example method 200 of FIG. 2.

It should be noted that the system 100 has been simplified. In other words, the system 100 may be implemented in a different form than that which is illustrated in FIG. 1. For example, the system 100 may be expanded to include additional networks, such as network operations center (NOC) networks, additional eUTRANs, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, SeGW 137, shared gateway 131 and SGW 134 may be combined into a single component. Alternatively, or in addition, server(s) 135 may be integrated with any one or more of such components. In still another example, various elements of eUTRAN 120, EPC network 130, and IMS core network 148 may be omitted for clarity, including gateways or border elements providing connectivity between such networks. Similarly, due to the relatively large number of connections available between devices in the system 100, various links between server(s) 135, shared gateway 131, SeGW 137, MME 132, SGW 134, AAA server 133, HSS 136, eNodeBs 121 and 122, PDN GW 138, and other components of system 100 are also omitted for clarity. Similarly, although the shared gateway 131, AS 135, HSS 136, AAA server 133, and SeGW 137 are illustrated as components within EPC network 130 having a particular configuration, in other examples, any one or more of these components may be deployed in a different configuration. For example, HSS 136 and/or AAA server 133 may be deployed in IMS core network 148, SeGW 137 may reside external to EPC network 130 within cellular network 110, and so on.

In addition, although aspects of the present disclosure have been discussed above in the context of a long term evolution (LTE)-based wireless network, examples of the present disclosure are not so limited. Thus, the teachings of the present disclosure can be applied to other types of wireless networks (e.g., a 2G network, a 3G network, a 5G network, an integrated network, e.g., including any two or more of 2G-5G infrastructure and technologies, and the like), that are suitable for use in connection with examples of the present disclosure for channel sounding via an in-service base station. For example, as illustrated in FIG. 1, the cellular network 101 may represent a “non-stand alone” (NSA) mode architecture where 5G radio access network components, such as a “new radio” (NR), “gNodeB” (or “gNB”), and so forth are supported by a 4G/LTE core network (e.g., a Evolved Packet Core (EPC) network 130). However, in another example, system 100 may instead comprise a 5G “standalone” (SA) mode point-to-point or service-based architecture where components and functions of EPC network 105 are replaced by a 5G core network, which may include an access and mobility management function (AMF), a user plane function (UPF), a session management function (SMF), a policy control function (PCF), a unified data management function (UDM), an authentication server function (AUSF), an application function (AF), a network repository function (NRF), a network slice selection function (NSSF), and so on. For instance, in such a network, server(s) 135 of FIG. 1 may represent an application function (AF) for configuring at least a portion of a second communication network that is selected to serve at least a first endpoint device in response to a network failure of a first carrier communication network, and for performing various other operations in accordance with the present disclosure. In addition, cellular network 110 may comprise 2G, 3G, 4G and/or LTE radios, e.g., in addition to 5G new radio (NR) functionality. For instance, in non-standalone (NSA) mode architecture, LTE radio equipment may continue to be used for cell signaling and management communications, while user data may rely upon a 5G new radio (NR), including millimeter wave communications, for example. Thus, these and other modifications are all contemplated within the scope of the present disclosure.

FIG. 2 illustrates a flowchart of an example method 200 for configuring at least a portion of a second communication network that is selected to serve at least a first endpoint device in response to a network failure of a first carrier communication network, in accordance with the present disclosure. In one example, steps, functions and/or operations of the method 200 may be performed by a network-based device, e.g., server(s) 135 in FIG. 1, or server(s) 135 in conjunction with other components of the system 100 such as backup networks (e.g., access network 125, satellite access network 127, wireless network 155), endpoint devices or other components that may be configured into a mesh network (such as vehicle 165, etc.), and so on. In one example, the steps, functions, or operations of method 200 may be performed by a computing device or system 300, and/or a processing system 302 as described in connection with FIG. 3 below. For instance, the computing device 300 may represent at least a portion of server(s) 135 in accordance with the present disclosure. For illustrative purposes, the method 200 is described in greater detail below in connection with an example performed by a processing system. The method 200 begins in step 205 and proceeds to step 210.

At step 210, the processing system (e.g., of a first carrier communication network) detects a network failure of at least a portion of a first carrier communication network, wherein the network failure prevents a network connectivity for at least a first endpoint device (broadly one or more first endpoint devices).

At step 220, the processing system selects, in response to the detecting of the network failure, a second communication network for the at least the first endpoint device from among one or more backup communication networks according to a selection logic. For example, the selected second communication network may comprise one of: a second carrier communication network, a private communication network, a mesh network of authorized access points, a non-terrestrial communication network, and so forth. For instance, in one example, the private communication network may comprise a private cellular network. In one example, the authorized access points of a mesh network may include vehicle-mounted mobile access points or access points with backup electrical power sources. In one example, the authorized access points may alternatively or additionally include devices of: at least one first responder entity and/or at least one governmental entity. For instance, these device may comprise hubs of a mesh network, which can also include other access points of other trusted entities, such as universities, hospitals, or the like. The mesh network may also include other non-hub nodes, either as access nodes or intermediate nodes. Likewise, the non-terrestrial access network may include at least one communication satellite and/or at least one aerial communication node. For example, an aerial communication node may include a balloon or uncrewed aerial vehicle (UAV) mounted base station, or could be mounted on a plane or helicopter, e.g., of a first responder or governmental entity, or of a commercial airplane or the like, which could provide temporary communications by circling/performing flyovers of an area, or in passing, which could at least provide sporadic emergency communications for critical devices of first responders or medical equipment, etc.

In one example, the second communication network may be designated as a primary backup communication network for at least a first class of endpoint devices including the at least the first endpoint device, e.g., according to the selection logic. In one example, the processing system may identify that the at least the first endpoint device for which the network failure prevents the network connectivity is of a first class of endpoint devices. In one example, the first class of endpoint devices may be designated for at least one of: first responder endpoint devices or network-communication-capable medical equipment. For instance, the selection logic may comprise an emergency network service plan, e.g., comprising one or more rules, tables, decision trees, or the like. In one example, the second communication network may be designated as the primary backup communication network for the at least the first endpoint device according to selection logic for the at least the first endpoint device, where the selection logic (e.g., an emergency network service plan) includes designations of the primary backup communication network and one or more secondary backup communication networks. In another example, the second communication network may be designated as a primary backup communication network for at least a second class of endpoint devices, where the at least the first class of endpoint devices is designated to obtain a first service level from the second communication network, and where the second class of endpoint devices is designated to obtain a second service level from the second communication network.

Alternatively, or in addition, the selection logic may comprise a machine learning model that is trained to generate an output comprising a selected backup network for the at least the first endpoint device. In one example, the output may further comprise a recommended set of resources and/or a level of service to be provided to the endpoint device or a class of endpoint devices. In one example, inputs to the machine learning model may include one or more of: the one or more backup communication networks that are available, a type of the network outage, a severity of the network outage, an anticipated duration of the network outage, a location of the network outage (e.g., the affected location, area, network element(s), and/or network zone), one or more temporal factors (e.g., a date, a time of day, a day of the week, a season of the year), and so forth. In one example, different MLMs may be trained and deployed for different network failure types, for different locations/areas, network elements, and or network zones, for different classes of endpoint devices, and so forth. Accordingly, in one example, step 220 may include selecting the appropriate MLM from among a plurality of available MLMs.

At step 230, the processing system configures at least a portion of the second communication network to serve the at least the first endpoint device. For instance, in one example, step 230 may include transmitting at least one instruction to the second communication network to reserve network resources of second communication network for the at least the first endpoint device (e.g., to reserve for the entire first class of endpoint devices or multiple classes of endpoint devices in need of a backup network to obtain different levels of services). For example, the network resources may include: link bandwidth for one or more links in the second communication network, processor capacity of at least one network element of the second communication network, memory capacity of at least one network element of the second communication network, or the like. To further illustrate, in a wireless network, e.g., a cellular network, link bandwidth can include air interface channel capacity in terms of channels, resource elements, or slots, e.g., in a time frequency resource grid, etc. Similar network resource allocations may be made in a satellite network, a non-cellular terrestrial wireless network, e.g., a Wi-Fi network, and so forth. Memory capacity or processor capacity can be for various network elements (e.g., hardware) comprising switches routers, PGWs or UPFs, SGWs, etc.

In one example, step 230 may include transmitting at least one instruction to the second communication network to activate a network slice of second communication network for the at least the first endpoint device. In other words, the network resources may comprise resources which may be allocated to a particular network slice that is designated or specifically allocated to serve the at least the first endpoint device (e.g., and/or the first class of endpoint devices to which the first endpoint device may belong). In this regard, it should be noted that the allocated network resources may include various network functions (e.g., virtual network functions (VNFs) or the like. As such, the at least the portion of the second communication network may include various physical and/or virtual network resources in an area that may serve the at least the first endpoint device, as well as core network elements, network functions, or the like, which may further support network connectivity for the at least the first endpoint device. In one example, the second communication network may provide the processing system with control over the network slice. For instance, the network slice may exist in a RAN portion of the second communication network, while cellular core network functions may still be provided via the infrastructure of the first carrier communication network. In addition, in an example in which the second communication network may comprise a mesh network, step 230 may include transmitting instructions to one or more hub nodes (e.g., designated trusted wireless access points, first responder vehicles or personal endpoint devices, etc.) or other endpoint devices to configure into an ad-hoc wireless mesh network (e.g., a peer-to-peer network). In one example, the processing system may instruct one or more network elements of the first carrier communication network to operate as hop-on/hop-off points, e.g., where the mesh network may interface with the first carrier communication network, such as one or more cellular base stations that are near to an area affected by a network outage, but which are not part of the network outage.

At step 240, the processing system establishes a network service for at least the first endpoint device via the at least the portion of the second communication network. In one example, the establishing may be in response to the identifying. In one example, step 240 may include transmitting, to the second communication network, a list of designated endpoint devices of the first class of endpoint device that are entitled to receive a first level of service (and/or a list of other endpoint devices that are not entitled to receive the first level of service and/or that are instead entitled to receive a second level of service, etc., such as endpoint devices of the second class of endpoint devices). In one example, step 240 may include obtaining a confirmation from the second communication network that the at least the first endpoint device has re-established network connectivity via the second communication network. In one example, the network service may include cellular or other core network operations, such as sending and receiving SMS messages, authenticating endpoint devices, providing location-based services, performing network-based firewall and filtering operations, and so forth. In one example, the network service may include establishing one or more communication paths for management data traffic and/or user data traffic via the first carrier communication network (e.g., a portion of the first carrier communication network that is not affected by the network failure). For instance, as noted above, a network slice may be reserved in RAN portion of the second communication network, while cellular core network functions may still be provided via the infrastructure of the first carrier communication network. Thus, the first carrier communication network may still perform admission control and may apportion bandwidth within the network slice, and so forth, e.g., as a guest MNO sharing the RAN infrastructure of the second communication network as host MNO.

At optional step 250, the processing system may detect a demand of a plurality of endpoint devices associated with the first carrier communication network for network services in excess of a capacity of the at least the portion of the second communication network. For example, the first endpoint device may monitor various performance indicators such as throughput, latency, packet loss, received signal strength, and so forth, to detect that a level of service is not according to an expected/designated level of service, or is otherwise inadequate. For instance, the first endpoint device may comprise a first responder device that is attempting to communicate with other first responder endpoint devices or non-first responder endpoint devices of those who may be in need of assistance. However, the first endpoint device may experience call failures, call drops, packet loss, packet delay, etc. Similarly, the first endpoint device may comprise a network-connected medical device, such as a surgical robot, a vitals monitoring system, etc., which may detect that network conditions/assigned level of service are inadequate to maintain uplink transmission of critical medical data and/or downlink transmission of remote control signals, or the like. In any case, the first endpoint device may transmit a request to the primary carrier network (e.g., to the processing system) indicating that a level of service is not adequate, and may request a transfer to another backup network and/or an upgrade of service via the second communication network. In one example, the request may be automatically generated by the endpoint device. In another example, the request may be user initiated. Alternatively, or in addition, the processing system may maintain communication with the second communication network to obtain notifications of deterioration of network conditions of the second communication network, or the like.

At optional step 260, the processing system may transmit an instruction to the second communication network to increase the capacity of the at least the portion of the second communication network. For instance, optional step 260 may be the same or similar to step 230. For example, the primary communication network may have a preexisting authorization to reserve up to a maximum amount of network resources of various types within the second communication network, and may not have previously reserved the maximum amount with respect to one or more network resources at step 230. Accordingly, step 260 the processing system may then request additional resources within the allotted limits. Alternatively, or in addition, the processing system may request additional network resources of the second communication network in excess of any pre-agreed amounts, but the second communication network may grant or deny the request depending on capability, availability of additional network resources that may be unused by native endpoint devices of the second communication network, and so forth.

At optional step 270, the processing system may offload at least one of the at least the first endpoint device to a third communication network. For example, the third communication network may comprise another one of: a carrier communication network, a private communication network, a mesh network of authorized access points, or a non-terrestrial communication network (e.g., that is different from the second communication network). To further illustrate, in one example, if the first endpoint device detects a trigger condition for obtaining a different service level, then the endpoint device may initiate a handoff to a third communication network to obtain additional network service at the different service level. In one example, a selection between optional step 260 and optional step 270 may be made in accordance with a user instruction received at optional step 250. Alternatively, or in addition, the selection may be made in accordance with the selection logic (e.g., with updated input(s) indicating lesser capacity in the second communication network, or removing the second communication network from the set of candidate available backup networks, or the like).

Following step 240 or any of optional steps 260 or 270, the method 200 may proceed to step 295. At step 295, the method 200 ends.

It should be noted that the method 200 may be expanded to include additional steps or may be modified to include additional operations with respect to the steps outlined above. For example, the method 200 may be repeated through various iterations of network failures and recoveries in the same or a different location, area, network zone, etc., through various cycles of backup networks losing capacity and/or having the ability to accommodate additional traffic/endpoint devices, and so forth. In one example, the method 200 may be expanded or modified to include steps, functions, and/or operations, or other features described in connection with the example(s) of FIG. 1 and/or FIG. 3, or as described elsewhere herein. Thus, these and other modifications are all contemplated within the scope of the present disclosure.

In addition, it should be noted that although not specifically specified, one or more steps, functions or operations of the method 200 may include a storing, displaying and/or outputting step as required for a particular application. In other words, any data, records, fields, and/or intermediate results discussed in the method 200 can be stored, displayed and/or outputted to another device as required for a particular application. Furthermore, steps or blocks in FIG. 2 that recite a determining operation or involve a decision do not necessarily require that both branches of the determining operation be practiced. In other words, one of the branches of the determining operation can be deemed as an optional step. In addition, one or more steps, blocks, functions, or operations of the above described method 200 may comprise optional steps, or can be combined, separated, and/or performed in a different order from that described above, without departing from the example embodiments of the present disclosure.

FIG. 3 depicts a high-level block diagram of a computing device or processing system specifically programmed to perform the functions described herein. For example, any one or more components or devices illustrated in FIG. 1 or described in connection with the method 200 may be implemented as the processing system 300. As depicted in FIG. 3, the processing system 300 comprises one or more hardware processor elements 302 (e.g., a microprocessor, a central processing unit (CPU) and the like), a memory 304, (e.g., random access memory (RAM), read only memory (ROM), a disk drive, an optical drive, a magnetic drive, and/or a Universal Serial Bus (USB) drive), a module 305 for configuring at least a portion of a second communication network that is selected to serve at least a first endpoint device in response to a network failure of a first carrier communication network, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for configuring at least a portion of a second communication network that is selected to serve at least a first endpoint device in response to a network failure of a first carrier communication network (e.g., a software program comprising computer-executable instructions) can be loaded into memory 304 and executed by hardware processor element 302 to implement the steps, functions or operations as discussed above in connection with the example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for configuring at least a portion of a second communication network that is selected to serve at least a first endpoint device in response to a network failure of a first carrier communication network (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents

What is claimed is:

1. A method comprising:
detecting, by a processing system including at least one processor of a first carrier communication network, a network failure of at least a portion of the first carrier communication network, wherein the network failure prevents a network connectivity for at least a first endpoint device;
selecting, by the processing system in response to the detecting of the network failure, a second communication network for the at least the first endpoint device from among one or more backup communication networks according to a selection logic;
configuring, by the processing system, at least a portion of the second communication network to serve the at least the first endpoint device; and
establishing, by the processing system, a network service for at least the first endpoint device via the at least the portion of the second communication network.

2. The method of claim 1, wherein the second communication network comprises:
a second carrier communication network;
a private communication network;
a mesh network of authorized access points; or
a non-terrestrial communication network.

3. The method of claim 2, wherein the authorized access points comprise:
vehicle-mounted mobile access points;
access points with backup electrical power sources;
at least one device of at least one first responder entity; or
at least one device of at least one governmental entity.

4. The method of claim 2, wherein the non-terrestrial communication network comprises at least one of:
at least one communication satellite; or
an aerial communication node.

5. The method of claim 1, wherein the second communication network is designated as a primary backup communication network for at least a first class of endpoint devices including the at least the first endpoint device according to the selection logic.

6. The method of claim 5, wherein the selecting comprising:
identifying that the at least the first endpoint device for which the network failure prevents the network connectivity is of the first class of endpoint devices.

7. The method of claim 5, wherein the second communication network is designated as a primary backup communication network for at least a second class of endpoint devices according to the selection logic, wherein the at least the first class of endpoint devices is designated to obtain a first service level from the second communication network according to the selection logic, and wherein the second class of endpoint devices is designated to obtain a second service level from the second communication network according to the selection logic, and wherein first service level is different from the second service level.

8. The method of claim 5, wherein the establishing comprises:
transmitting, to the second communication network, a list of designated endpoint devices of the first class of endpoint device that are entitled to receive a first level of service.

9. The method of claim 1, wherein the selection logic comprises a machine learning model that is trained to generate an output comprising a selected backup network for the at least the first endpoint device.

10. The method of claim 9, wherein inputs to the machine learning model include one or more of:
the one or more backup communication networks that are available;
a type of the network outage;
a severity of the network outage;
an anticipated duration of the network outage;
a location of the network outage; or
one or more temporal factors.

11. The method of claim 1, wherein the establishing comprises:
obtaining a confirmation from the second communication network that the at least the first endpoint device has re-established a network connectivity via the second communication network.

12. The method of claim 1, wherein the configuring comprises:
transmitting at least one instruction to the second communication network to reserve network resources of the second communication network for the at least the first endpoint device.

13. The method of claim 12, wherein the network resources comprise at least one of:
a link bandwidth for one or more links in the second communication network;
a processor capacity of at least one network element of the second communication network; or
a memory capacity of at least one network element of the second communication network.

14. The method of claim 1, wherein the configuring comprises:
transmitting at least one instruction to the second communication network to activate a network slice of second communication network for the at least the first endpoint device.

15. The method of claim 1, further comprising:
detecting a demand of a plurality of endpoint devices associated with the first carrier communication network for network services in excess of a capacity of the at least the portion of the second communication network.

16. The method of claim 15, further comprising at least one of:
transmitting an instruction to the second communication network to increase the capacity of the at least the portion of the second communication network; or
offloading at least one of the at least the first endpoint device to a third communication network.

17. The method of claim 1, wherein when the at least the first endpoint device detects a trigger condition for obtaining a different service level, the endpoint device will initiate a handoff to a third communication network to obtain an additional network service at the different service level.

18. The method of claim 1, wherein the second communication network is designated as the primary backup communication network for the at least the first endpoint device according to an emergency network service plan for the at least the first endpoint device that, where the emergency network service plan includes designations of the primary backup communication network and one or more secondary backup communication networks.

19. A non-transitory computer-readable medium storing instructions which, when executed by a processing system including at least one processor deployed in a first carrier communication network, cause the processing system to perform operations, the operations comprising:
detecting a network failure of at least a portion of the first carrier communication network, wherein the network failure prevents a network connectivity for at least a first endpoint device;
selecting, in response to the detecting of the network failure, a second communication network for the at least the first endpoint device from among one or more backup communication networks according to a selection logic;
configuring at least a portion of the second communication network to serve the at least the first endpoint device; and
establishing a network service for at least the first endpoint device via the at least the portion of the second communication network.

20. An apparatus comprising:
a processing system including at least one processor; and
a computer-readable medium storing instructions which, when executed by the processing system, cause the processing system to perform operations, the operations comprising:
detecting a network failure of at least a portion of the first carrier communication network, wherein the network failure prevents a network connectivity for at least a first endpoint device;
selecting, in response to the detecting of the network failure, a second communication network for the at least the first endpoint device from among one or more backup communication networks according to a selection logic;
configuring at least a portion of the second communication network to serve the at least the first endpoint device; and
establishing a network service for at least the first endpoint device via the at least the portion of the second communication network.
